(19) United States
(12) Patent Application Publication
(10) Pub. No.: US 2001/0025939 A1
(43) Pub. Date: Oct. 4, 2001

(54) Self-closing water-saving device for faucet

(76) Inventor: Jong-Gyun Lee, Kwangju-City (KR)

Correspondence Address: Charles F. Wieland III, BURNS, DOANE, SWECKER & MATHIS, L.L.P., P.O. Box 1404, Alexandria, VA, 22313-1404, US

(21) Appl. No.: 09/817,024

(22) Filed: Mar. 27, 2001

(30) Foreign Application Priority Data
Mar. 28, 2000 (KR) 15914/2000

(51) Int. Cl. F16K 31/48

(52) U.S. Cl. 251/54; 251/246

(57) ABSTRACT

The present invention relates to a self-closing water-saving device for a faucet which enables a user only not to use the both hands for constant times by holding up a lever in using water but also quickly select the lever operation of the faucet water opening or closing. And the present is minimized for a simple installation. The self-closing water-saving device which an end an end mounted to the faucet for controlling hot and cold water amount by connecting to a main pipe, and the other end for spouting water, the self-closing water-saving device comprises a lever for opening a water-path path when rotating the lever and closing after a constant time by an elastic force of an elastic member and oil flowing or friction; a water-saving means for closing the water-path when rotating the lever to the other side in the condition of opening the water-path; and a faucet-connecting member for connecting the water-saving means to the faucet.

### BACKGROUND OF THE INVENTION

1. Field of the Invention

The present invention relates to a self-closing water-saving device for a faucet manufactured as a small scale, which particularly cannot only save water but also prevent an auto-hammer.

2. Description of the Background Art

A conventional faucet is operated a faucet handle to hold up or down by using a hand and includes an opening or closing water-path operated to the direction of up, down, left or right side.

Accordingly, even a user, who is using two hands for washing dishes or taking a shower doing like soaping, washing hair or shaving, turns the handle of the faucet for opening or closing the water-path and controls the water amount.

However, there is a problem that precious water resources are wasted by the user's troublesome and ignorance of leaving without immediately closing the faucet in using the water.

### SUMMARY OF THE INVENTION

It is an object of the present invention to provide a water-saving device for a faucet which enables a user only not to use the both hands for constant times by holding up a lever in using water but also quickly select the lever operation of the faucet water opening or closing.

It is another object of the present invention to provide a self-closing water-saving device for easily installing by a miniaturization.

To achieve the above objects, self-closing water-saving device which an end an end mounted to the faucet for controlling hot and cold water amount by connecting to a main pipe, and the other end for spouting water, the self-closing water-saving device comprising: a lever for opening a water-path path when rotating the lever and closing after a constant time by an elastic force of an elastic member and oil flowing or friction; a water-saving means for closing the water-path when rotating the lever to the other side in the condition of opening the water-path; and a faucet-connecting member for connecting the water-saving means to the faucet.

The water-saving device includes a water-path opening or closing section for opening or closing the water-path formed on a lateral side while the faucet-connecting member is fastened externally with moving toward an axial direction internally. A control section of the water-path opening or closing opens the water-path by coupling to be sealed an end to the water-path opening or closing section and by operating an operating force toward one side to the other end, and the other end sealed closes the water-path by the elastic force of the elastic member and oil flowing or friction after the constant time. An operating section of the water-path opening or closing is not fixed on the other end of the control section thereof but also on the wall by the fixing means for inflicting an external force to a point of the water-path opening or closing on the control section of the water-path opening or closing.

### BRIEF EXPLANATION OF THE DRAWINGS

The above objectives and advantages will become more apparent with explanation of the accompanying drawings:

FIG. 1 is a front side view showing a status of using a faucet installed a water-saving device according to the present invention;

FIG. 2 is a lateral-side view showing a water-saving device according to the present invention;

FIG. 3 is a partial cross-sectional view showing a status of a closed water-path as an installed state of a self-closing water-saving device on a wall according to the present invention;

FIG. 4 is an exploded assembling view showing a water-saving device according to the present invention;

FIG. 5 is a cross-sectional view cut by an A-A line in FIG. 4;

FIG. 6 is a cross-sectional view cut by a B-B line in FIG. 4;

FIG. 7 is a lateral-side view of a fastening member as a component of a water-saving device according to the present invention;

FIG. 8 is a cross-sectional view cut by a C-C line in FIG. 4;

FIG. 9 is a cross-sectional view cut by a D-D line in FIG. 4; and

FIG. 10 is a partial cross-sectional view showing a status of an open water-path as an installed state of a self-closing water-saving device on a wall according to the present invention.

### DETAILED DESCRIPTION OF THE INVENTION

An embodiment of the present invention will now be explained in detail with reference to the accompanying drawings.

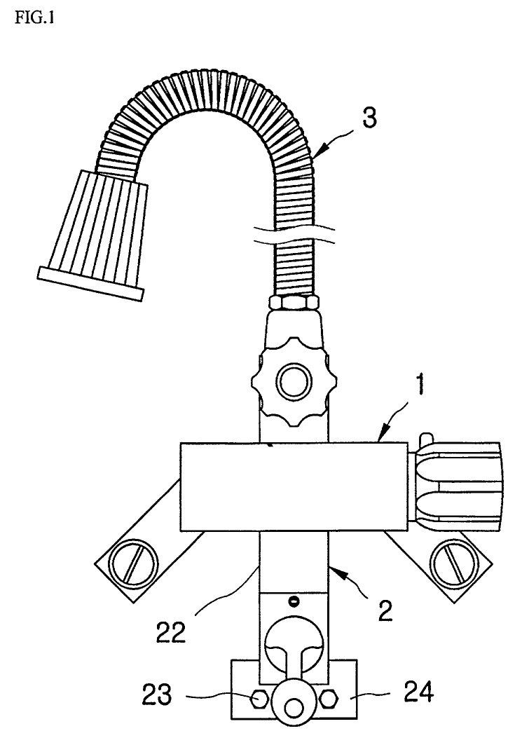

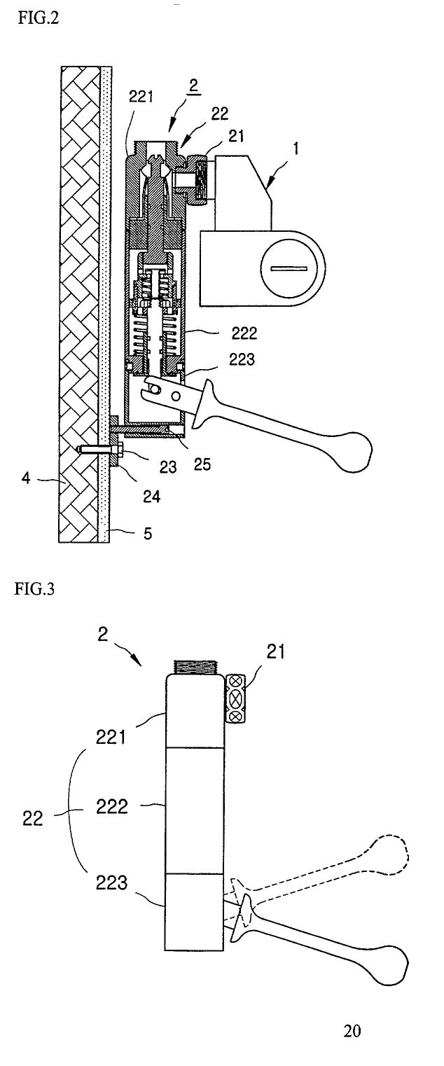

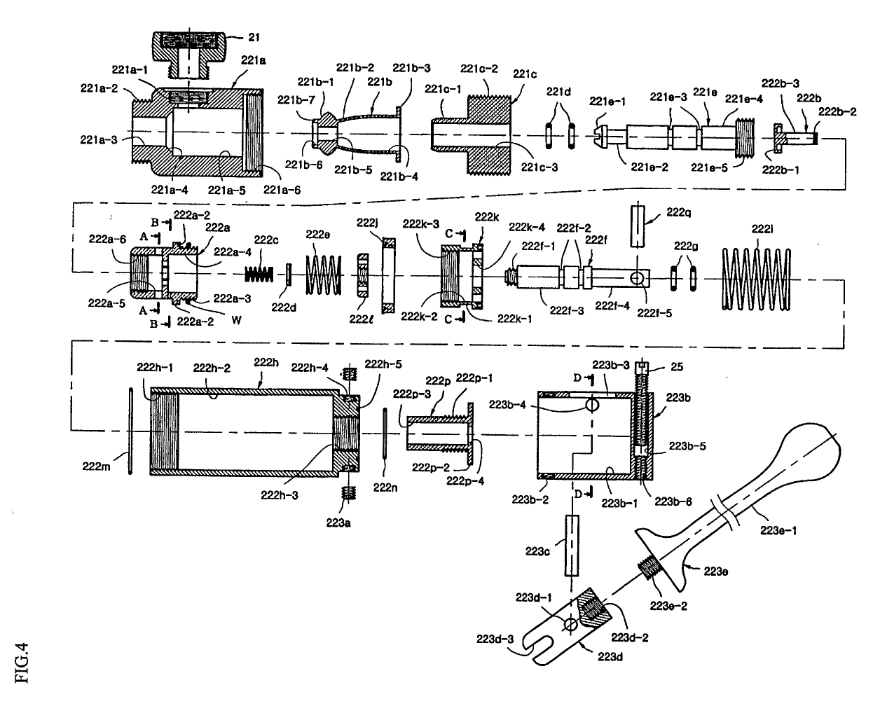

FIG. 1 is a front side view showing a status of using a faucet installed a water-saving device according to the present invention. FIG. 2 is a lateral-side view showing a water-saving device according to the present invention. FIG. 3 is a partial cross-sectional view showing a status of a closed water-path as an installed state of a self-closing water-saving device on a wall according to the present invention. FIG. 4 is an exploded assembling view showing a water-saving device according to the present invention.

Referring to FIGS. 1 through 3, the self-closing water-saving device 2 is mounted on one side of the faucet 1 installed on the wall, etc. for controlling hot and cold water amount by connecting to a main pipe, and a shower device 3 is mounted on one side of the water-saving device 2 for spraying water according to the opening or closing of the water-path by the water-saving device 2.

The water-saving device 2 includes the faucet-connecting member 21, the water-saving device 22, a fastener 23, a bracket 24 and a fixing means 25.

The faucet-connecting member 21 is coupled the end of the water-saving device 22 with the faucet 1.

In the water-saving device 22, a water-path is open when rotating a lever of the water-saving device to one side. The water-path is closed by an elastic force of an elastic member and oil flowing or friction after a constant time and by rotating the lever to the other side in opening the water-path.

The fastener 23 is a bolt for fixing the bracket 24 on the wall 4 or the tile 5 and the fixing means 25 is a screw nail for fixing the water-saving device 22 to the bracket 24.

The water-saving device 22 includes a water-path opening or closing section 221 for opening or closing the water-path formed on a lateral side while the faucet-connecting member 21 is fastened externally with moving toward an axial direction internally A control section 222 of the water-path opening or closing opens the water-path by coupling to be sealed an end to the water-path opening or closing section 221 and by operating an operating force toward one side to the other end, and the other end sealed closes the water-path by the elastic force of the elastic member and oil flowing or friction after the constant time. An operating section 223 of the water-path opening or closing is not fixed on the other end of the control section 222 thereof but also on the wall by the fixing means 25 for inflicting an external force to a point of the water-path opening or closing on the control section 222 thereof.

Referring to FIG. 4, the water-path opening or closing section 221 includes a water-path forming case 221 a fastening the faucet-connecting member 21 to be coupled to form the water-path on one side. A dome-typed packing 221b made of a rubber material is coupled for opening or closing the water-path by inserting to the inside of the water-path forming case 221. A packing shaft housing 221c is fastened to the water-path forming case 221a for sealing the dome-typed packing 221b to the water-path forming case 221a by pressurization. A packing shaft 221e is mounted to open or close the water-path forming case 221a and the water-path by moving the dome-typed packing 221b to the axial direction when moving a front end penetrated through the dome-typed packing 221b toward the central direction of the shaft with installing an O-ring on a predetermined position to be sealed by inserting toward the center of the packing shaft housing.

The water-path forming case 221 a includes a screw section 221a-1 fastening the faucet-connecting member 21 on the outer surface; a male screw section 221a-2 fastening the shower device 3; a water-path hole 221a-3 formed -inside the male screw section 221a-2; a packing reaching surface 221a-4 for tightly attaching with the dome-typed packing 221b by being extended in a predetermined curve from the water-path hole 221a-3; a dome packing installation groove 221a-5 coupled with the packing reaching surface 221a-4 and the screw section 221a-1; and a screw section 221a-6 fastening the packing shaft housing 221c to be coupled with the dome-typed packing installation groove 221a-5.

The dome-typed packing 221b includes a water-path opening or closing section 221b-1 for reaching to the packing reaching surface 221a-4 as inserted to the water-path hole 221a-3; a gearing section 221b-2 coupled with the water-path opening or closing section 221b-1 for giving elasticity; a flange 221b-3 for tightly attaching to a boundary of the dome-typed pack installation groove 221a-5 and the screw section 221a-6; an inserting section 221b-4 for inserting an end of the packing shaft housing 221c by forming in an axial direction of the gearing section 221b-2 and the flange 221b-3; a packing shaft fixing groove 221b-6 for coupling the gearing section formed on the opposite side of the coupled hole 221b-5 to be inserted the packing shaft 221e to the inserting section 221b-4; and an auto-hammer preventing groove 221b-7 slantingly formed at a predetermined angle in regular intervals on the water-path opening or closing section 221b-1 which is some distance away from the packing shaft fixing groove 221b-6.

The packing shaft housing 221c includes a fixed cylinder section 221c-1 inserted to the inserting section 221b-4; a male screw section 221c-2 fastened to the screw section 221a-6 in a state of being more extended diameter than the fixed cylinder section 221c-1; and a penetrating hole 221c-3 for inserting the packing shaft 221e penetrated to the center of an axial direction of the fixed cylinder section 221c-1 and the male screw section 221c-2.

The packing shaft 221e includes a hook section 221e-1 reached to the packing shaft fixing groove 221b-6 from the outside; a packing coupling section 221e-2 extended from the hook section and inserted to the hole 221b-5; a sliding shaft section 221e-4 forming a plurality of grooves 221e-3 inserting the O-ring 221d with extending with the packing coupling section 221e-2 by being unified as a body; and a male screw section 221e-5 for coupling with an oil-path forming housing 222a in the next following explanation which is extended to the slide shaft section 221e-4 on the extended outer surface.

The control section 222 of water-path opening or closing includes the oil-path forming housing 222a having a predetermined shape for forming an oil-path by fastening an end with the packing shaft 221e; an oil-path opening or closing pin 222b for opening or closing the oil-path of an axial direction with moving as being inserted toward an axial direction of the oil-path forming housing 222a; a first elastic member 222c such as a. spring, etc. inserted toward the other direction of the oil-path opening or closing pin 222b and reached inside the center of the oil-path forming housing 222c; an E-ring 222d placed inside the center of the oil-path forming hosing 222a and inserted to the oil-path opening or closing pin 222b for preventing a separation of the first elastic member 222c; and a second elastic member 222e such as a spring, etc. inserted to the oil-path forming housing 222a to be placed on an outer side of the first elastic member 222c.

And the self-closing water-saving device includes an extension shaft 222f of a predetermined length, an O-ring 222g coupled to a predetermined point, and an oil containing hosing 222h inserted the extension shaft 222f to the center of the shaft and an end is fastened to the packing shaft housing 221c. A third elastic member 222i is inserted to the fastening side with the packing shaft housing 221c of the oil-path containing housing 222h. An oil packing 222j is inserted to an outer circumstance for dividing the oil in the oil containing housing 222h and is moved as being tightly attached to the inside of the oil containing housing 222h with being inserted the third elastic member 222i to the inserted oil containing housing 222h. And an oil dividing bushing 222k is fastened to the oil-path forming housing 222a for containing the second elastic member 222e by means of an O-ring W.

Also a coupling member 2221 pressurizes the third elastic member 222i to the inside of the oil containing housing 222h as being fastened the extension shaft 222f to the oil dividing bushing 222k. An O-ring 222m is placed on the contact surface of the water-path forming case 221a and the oil containing housing 222h for preventing the oil leakage in thereof as being fastened the water-path forming case 221a and the oil containing housing 222h to the packing shaft housing 221c. An oil cap 222p prevents the oil leakage to a lower side as being fastened by means of an O-ring 222n placed on a rear side of the oil containing housing 222h and as being moved the extension shaft 222f upward and downward by means of the O-ring 222g. And a pin 222q of a predetermined length is inserted to the other end of the extension shaft 222f at a rectangular angle.

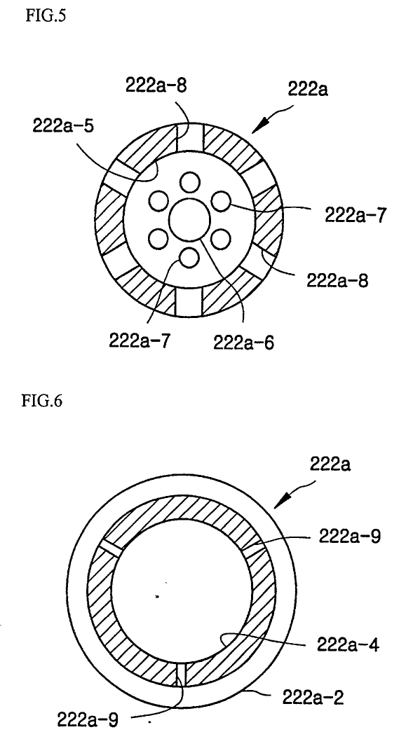

Referring to FIGS. 4 through 6, the oil-path forming housing 222a comprises a flange 222a-2 mounted the reaching groove 222a-1 having the reached O-ring W on a lateral side; a male screw section 222a-3 formed on an outer surface extended with the flange for fastening to the oil dividing bushing 222k; an elastic member containing groove 222a-4 formed on the center of the axis of the male screw section 222a-3 for containing the first and second member 222c and 222e; a containing groove 222a-5 of the oil-path opening or closing pin for flowing to a predetermined height as being contained the oil-path opening or closing pin 222b by forming at a predetermined depth on the other end which the elastic member containing groove is formed; a female screw section 222a-6 formed on an end of the containing groove of the oil-path opening or closing pin for fastening to the mail screw section 221e-5; an inserting hole 222a-6 of the oil-path opening or closing pin formed on the center of an axis of a septum formed by the elastic member containing groove 222a-4 and the containing groove 222a-5 of the oil-path opening or closing pin; a plurality of penetrating oil-paths 222a-7 formed around the inserting hole 222a-6 at a predetermined angle; a plurality of discharging oil-paths 222a-8 penetrated and formed on an outer surface of the containing groove of the oil-path opening or closing pin at a predetermined angle; and a plurality of absorption oil-paths 222a-9 formed as being penetrated on an outer surface of the containing groove interval 222a-4 of the elastic member 222a-4.

The oil-path opening or closing pin 222b comprises a valve section 222b-1 equipped on an end to be attached or detached to the septum for opening or closing the inserting hole 222a-6 of the oil-path opening or closing pin and the penetrating oil-path 222a-7, and a shaft section 222b-3 having a groove 222b-2 for inserting the E-ring 222d as being extended to the other end of the valve section.

And the extension shaft 222f comprises a mal screw section 222f-1 fastened to the coupling member 2221 by inserting to the oil dividing bushing 222k; a shaft section 222f-3, having a groove 222f-2 where the O-ring 222g is inserted to a predetermined position and extended with the male screw section; an extension section 222f-4, having a comparatively smaller diameter with extending to the shaft section; and a hole 222f-5 where the pin 222q is inserted as being formed on a predetermined position of the extension section.

The oil containing housing 222h comprises a female screw section 222h-1 formed at the center of the axis for fastening with the male screw section 221c-2 of the packing shaft housing 221c; a oil containing groove 222h-2 formed as a predetermined depth with a respectively small diameter for coupling with the female screw; a female screw 222h-3 fastened the oil cap 222p for coupling with the oil containing groove; a female screw section 222h-4 formed as a smaller size than the outer surface of the female screw section 222h-1 and the oil containing groove 222h-2 for coupling with the opening or closing in the next following explanation; and an O-ring reaching groove 222h-5 to be reach the O-ring for preventing the oil leakage in the coupled state of the oil cap 222p formed on the lateral side of the female screw 222h-3.

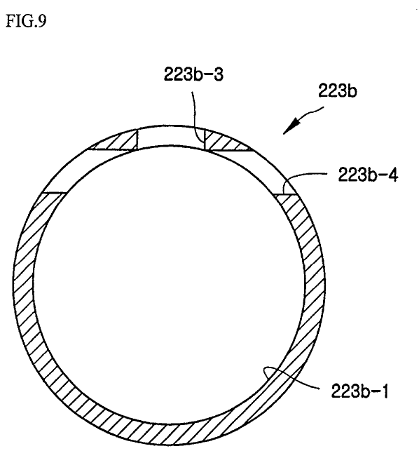

Referring to FIGS. 4 and 8, the oil dividing bushing 222k comprises a groove 222k-1 formed on a predetermined position of an outer surface for the oil packing 222j to be reached and inserted; a coupling member reaching groove 222k-2 formed at a predetermined depth for reaching the coupling member 222l to be movable toward an axial direction; a female screw section 222k-3 for fastening the male screw section 222a-3 of the oil-path forming housing 222a at a predetermined depth on a front end of the coupling member reaching groove; a penetrating hole 222k-4 for inserting the shaft section 222f-3 of the extension shaft 222f on the septum formed by the coupling member reaching groove 222k-2; a plurality of oil-path penetrating holes 222k-5 formed at a predetermined angle around the penetrating hole; and a spring reaching groove 222k-6 for supporting an end of the third elastic member 222i on the outer wall which the penetrating hole 222k-4 and the oil-path penetrating hole 222k-S are formed.

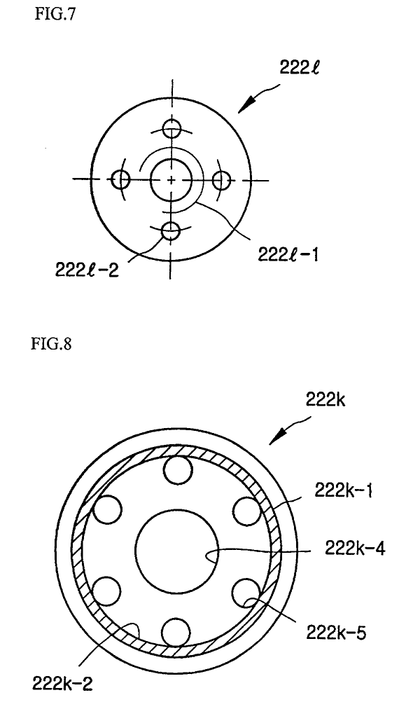

Referring to FIGS. 4 and 7, the coupling member 2221 comprises a female screw 222l-1 fastened to the male screw section 222f-1 of the extension shaft 222f on the center of the shaft and a plurality of oil-path holes 222l-2 at a predetermined angle around the female screw.

And the oil cap 222p comprises a male screw section 222p-1, for fastening to the female screw 222h-3 on a predetermined position of an outer circumstance which an end is inserted to the female screw 222h-3; a flange 222p-2 for tightly attaching an O-ring 222n to an O-ring reaching groove 222h-5 of the oil containing housing 222h as being extended with the male screw section; an shaft guiding groove 222p-3 formed at a predetermined depth for moving the shaft section 222f-3 of the extension shaft 222f at the center of the shaft which the male screw is formed; and a guide hole 222p-4 for the extension shaft penetrated toward the flange 222p-2 from the shaft guiding groove.

The control section 223 of water-path opening or closing comprises an opening or closing housing 223b coupled by means of a fastening device 223a such as a screw fastened to a rear end of the oil containing housing 222h; a pivoting arm 223d for tying up a pin 222q inserted to the extension shaft 222f by pivoting with a pin 223c inserted to the opening or closing housing 223b; and a lever 223e coupled with the pivoting arm 223d.

Referring to FIGS. 4 and 9, the opening or closing housing 223b comprises an opening or closing operation playing groove 223b-1 formed at a predetermined depth for inserting an end to the read side of the oil containing housing 222h; a female screw section 223b-2 coupled with the opening or closing operation playing groove for fastening the fastening device; an opening or closing operation groove 223b-3 coupled the opening or closing operation playing groove 223b-1 with the outer surface for freely pivoting the pivoting arm 223d; a pin fixing foramen 223b-4 penetrated and formed at the rectangular angle to the axial direction on the lower part of the opening or closing operation groove; a containing groove 223b-5 formed at a predetermined depth at the rectangular angle to the axial direction on the other end which the opening or closing operation playing groove 223b-1 is formed for containing the fixing means 25; and a female screw section 223b-6 for coupling with the outer surface in the lower part of the containing groove.

The pivoting arm 223d has a pin hinge foramen 223d-1 penetrated and formed at a center for pivoting by means of the pin 223c inserted to the pin fixing foramen 223b-4; a female screw section 223d-2 for fastening to the lever 223e on an end as a standard point formed the pin hinge foramen; and a pin gripping section 223d-3 formed as an U-shape for moving upward or downward by gripping the pin 222q to the other end as a standard point thereof.

Also the lever 223e includes a gripping section 223e-1 formed as a minimized shape for easily operating by hand, and a male screw section 223e-2 mounted on an end of the gripping section and fastened to the female screw section 223d-3 of the pivoting ann 223d. Here the pivoting arm 223d and the lever 223e is formed as a body.

An assembling of the water-saving device 22 will be explained by the followings. The O-ring 221d is coupled with the groove 221e-3 of the packing shaft 221e and inserted to the packing shaft housing 221c and the dome-typed packing 221b. The male screw section 221c-2 of the packing shaft housing 221c is fastened to the screw section 221a-6 of the water-path forming case 221a for tightly attaching the flange 221b-3 of the dome-typed packing 221b to the boundary surface between the dome-typed packing installation groove 221a-5 and the screw section 221a-6.

Then, the first elastic member 222c in inserted and fixed with the E-ring from the opposite side as being inserted state of the shaft section 222b-3 of the oil-path opening or closing pin 222b.

And the oil packing 222j is inserted to the center of the axial direction of the oil dividing bushing 222k reached on the groove 222k-1 of the outer surface and the coupling member 222l is fastened to the male screw section 222f-1 of the extension shaft 222f.

Next, the O-ring W is placed on the reaching groove 222a-1 formed on the flange 222a-2 of the oil-path forming housing 222a as the status of being inserted the second elastic member 222e to the elastic member containing groove 222a-4 of the oil-path forming housing 222a, and the female screw section 222k-3 of the oil-path forming housing 222a is fastened with the male screw section 221e-5.

Then, the male screw section 221e-5 of the packing shaft 221e is fastened with the female screw section 222a-6 of the oil-path forming housing 222a.

After the third elastic member 222i is put in the oil containing groove 222h-2 of the oil containing housing 222h and the extension shaft 222f is penetrated to the female screw section 222h-3, then the O-ring 222m is put on the screw section 221c-2 of the packing shaft housing 221c and the female screw section 222h-1 of the oil containing housing 222h is fastened.

The oil O is poured between the female screw section 222h-3 and the extension shaft 222f and the O-ring is positioned, then finally the oil cap 222p is fastened.

Then, the opening or closing housing 223b is fastened as the fastening means 223a by inserting to the oil containing housing 222h as the inserted state of pin 222q to the hole 222f-5 formed on the extension section 222f-4 of the extension shaft 222f projected to the rear side of the oil cap 222p.

Also, the pivoting arm 223d is fastened and coupled with the lever 223e and the pin gripping section 223d-3 of the pivoting arm 223d is inserted to the pin 222q. Then the pin 222q is inserted to the pin fixing foramen 223b-4 and pin hinge foramen 223d-1 for pivoting.

The water-path forming case 221a is coupled with the faucet by means of the faucet-connecting member 21 and the shower device 3 is coupled with the male screw section 221a-2. And then the installation will be finished when the opening or closing housing 223b of the water-path operation section 223 is fixed to the bracket 24 fixed as a fastening means 23 on the wall 4 and the tile 5 by means of the fixing means.

When the operating status is explained in using the water-saving device 22 of the present invention comprised as like the above, the lever 223e is in the down to the lower part as shown in FIG. 3 in the opening state of the faucet 1 and the water-path becomes to the closed state.

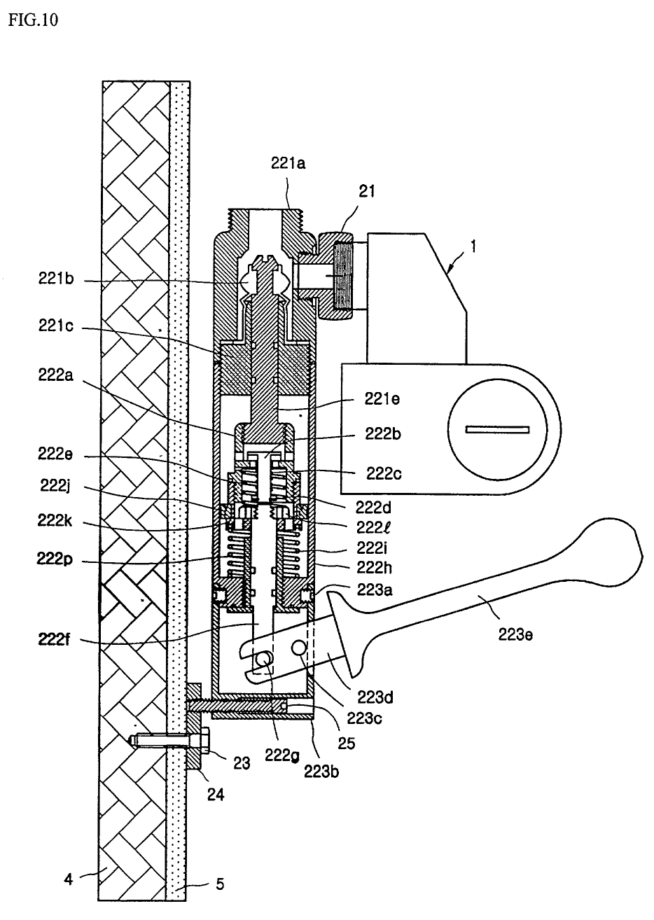

Referring to FIG. 10, when the lever 223e is raised upward, the pivoting arm 223d is pivoted at the rotary center of the pin, and the pin 222q inserted to the extension shaft 222f is pulled downward.

Simultaneously, the other end of the extension shaft 222f is fastened with the coupling member 222l so that water is sprayed through the shower device 3 by opening the water-path of the faucet 1 and the shower device 3 as moving down the oil dividing bushing 222k, the oil-path forming housing 222a, the packing shaft 221e and the dome-typed packing 221b to the lower part against the elastic force of the third elastic member 222i.

Meanwhile, as moving the oil dividing bushing 222k, the oil-path forming housing 222a, the packing shaft 221e and the dome-typed packing 221b to the lower part, the oil O in the lower part of the oil packing 222j, the oil-path opening and closing pin 222b is raised upward by generating pressure on the oil dividing bushing 222k and the oil-path forming housing 222a. And the oil O is discharged to the upper part by opening the penetrating oil-path 222a-7.

When a predetermined amount of the oil is discharged to the upper part, the valve 222b-1 of the oil-path opening or closing 222b closed the penetrating oil-path 222a-7.

Then the oil, raised to the upper part of the oil packing 222j, the oil dividing bushing 222k and the oil-path forming housing 222a by continuously spraying the water to the shower device 3, pushes the oil packing 222j, the oil dividing bushing 222k and the oil-path forming housing 222a to the upper part against the elastic force of the third elastic member 222i. At this time, the oil is slowly flown in the lower part through the absorption oil-path 222a-9 of the oil-path forming housing 222a.

When the oil is continuously flown for a constant time and the water-path opening or closing section 221b-1 of the dome-typed packing 221b is tightly attached to the water-path hole 221a-3 and the packing reaching surface 221a-4, water-pressure is added to the rear side of the water-path opening or closing section 221b-1 for quickly closing the water-path.

The auto-hammer state generated in closing the water-path is prevented according to comparatively narrowing the water-path by a slant auto-hammer preventing groove 221b-7 formed on the water-path opening or closing section 221b-1 of the dome-typed packing 221b.

The influx speed of the oil to the lower part is determined by friction of the oil packing 222j and oil containing housing 222h and the elastic coefficient of the third elastic member 222i, therefore, the water-path can be open or closed for a determined time by controlling the speed.

Meanwhile, the water is used in the open state of the water-path by raising the lever 223e upward and not needed to be used any more, the top end of the extension shaft 222f becomes the state of raising the oil-path opening or closing pin 222b with a little movement of the lower part of the lever 223e. Then the oil-path opening or closing pin 222b is raised and the penetrating oil-path 222a-7 is open. Simultaneously, the elastic force of the third elastic member 222i quickly raises the lever upward and the water-path opening or closing section 221b-1 of the dome-typed packing 221b is tightly attached to the water-path hole 221a-3 of the water-path forming case 221a and the packing reaching surface 221a-4 for quickly closing the water-path.

As described above, the water-saving device 22 has an effect that water resources is not unnecessarily wasted with only one operation in the case of the user's absence through carelessness or of not using the water because of supplying the water only for a determined time.

There is another effect that the unnecessary water waste is prevented by quickly blocking the water-path when water is not needed even during the time of using water.

There is still another effect that the installation is simple by making a minimization of the water-saving device.

While the present invention has been described herein with reference to particular embodiments thereof, latitude of modification, various changes and substitutions are intended in the foregoing disclosure. And in some instances, some features of the invention will be employed without a corresponding use of other features without departing from the spirit of the invention as set forth herein.

What is claimed is:

1. A self-closing water-saving device which an end an end mounted to the faucet for controlling hot and cold- water amount by connecting to a main pipe, and the other end for spouting water, the self-closing water-saving device comprising:
a lever for opening a water-path path when rotating the lever and closing after a constant time by an elastic force of an elastic member and oil flowing or friction;
a water-saving means for closing the water-path when rotating the lever to the other side in the condition of opening the water-path; and
a faucet-connecting member for connecting the water-saving means to the faucet.

2. The self-closing water-saving device of claim 1, wherein the water-saving means comprising:
a water-path opening or closing section for opening or closing the water-path formed on a lateral side with fastening a faucet-connecting member externally and moving toward an axial direction internally;
a control section of the water-path opening or closing for opening the water-path by coupling to be sealed an end to the water-path opening or closing section and by applying an operating force toward one side on the other end, and the other end which is also sealed for closing the water-path by the elastic force of the elastic member and oil flowing or friction after the constant time; and
an operating section of the water-path opening or closing, fixed on the other end of the control section thereof and on the wall by a fixing means, for inflicting an external force to a point of the water-path opening or closing on the control section thereof.

3. The self-closing water-saving device of claim 2, the water-path opening or closing section comprising:
a water-path forming case fastened the faucet-connecting member to form the water-path on a side of the faucet-connecting member;
a dome-typed packing for coupling to open or close the water-path by inserting to the inside of the water-path forming case;
a packing shaft housing, fastened to the water-path forming case, for sealing the dome-typed packing to the water-path forming case by pressurization;
an O-ring mounted on a predetermined position to be sealed by inserting toward the center of the packing shaft housing; and
packing shaft mounted to open or close the water-path forming case and the water-path by moving the dome-typed packing to the axial direction when moving a front end penetrated through the dome-typed packing toward the central direction of the shaft.

4. The self-closing water-saving device of claim 2, the control section of the water-path opening or closing comprising:
an oil-path forming housing having a predetermined shape for forming an oil-path by fastening an end with the packing shaft;
an oil-path opening or closing pin for opening or closing the oil-path of an axial direction with moving as inserted toward an axial direction of the oil-path forming housing;
a first elastic member inserted toward the other direction of the oil-path opening or closing pin and reached inside the center of the oil-path forming housing;
an E-ring placed inside the center of the oil-path forming hosing and inserted to the oil-path opening or closing pin for preventing a separation of the first elastic member; and
a second elastic member inserted to the oil-path forming housing to be placed on an outer side of the first elastic member.

5. The self-closing water-saving device of claim 2, the operating section of the water-path opening or closing comprising:
an opening or closing housing coupled by means of a fastening device such as a screw member fastened to a rear end of the oil containing housing;
a pivoting arm for tying up a pin inserted to the extension shaft by pivoting with a pin inserted to the opening or closing housing; and
a lever coupled with the pivoting arm.

6. The self-closing water-saving device of claim 2, wherein the pivoting arm and the lever are formed as a body.
